(19) United States
(12) Patent Application Publication
(10) Pub. No.: US 2015/0231024 A1
(43) Pub. Date: Aug. 20, 2015

(54) Wearable Massager for Couples

(71) Applicant: LELO Inc., San Jose, CA (US)

(72) Inventor: Filip Sedic, Shanghai (CN)

(21) Appl. No.: 14/184,689

(22) Filed: Feb. 19, 2014

(51) Int. Cl. A61H 19/00

(52) U.S. Cl. CPC A61H 19/50; A61H 19/44; A61H 19/34; A61H 2201/5097

(57) ABSTRACT

A remote-controllable wearable massager for couples including a first arm, a second arm, and a connecting member coupling the first arm to the second arm provides massaging motion for a user and can be used by the user during sexual intercourse with a partner. During operation, the first arm of the massager is inserted into the user's vagina and the second arm rests on the region near the user's clitoris. The connecting member is configurable such that the user can flexibly adjust the distance between the first arm and the second arm of the massager to allow for insertion of the first arm into a vagina, and rigid enough to forcibly compress the first arm towards the second arm, allowing the massager to be worn as a clip. During operation, the distal end of the first arm rotates about the intersection between the first arm and the connecting member.

### BACKGROUND

The present invention relates generally to personal massagers, and more particularly to remote-controllable wearable massagers for couples.

Personal massaging devices have been developed in a variety of shapes and sizes to provide stimulation and/or massage nearly every part of the human body. Personal massagers can perform in a number of manners. Conventional massagers, such as hand-held massagers, are usually configured for use by one operator for the operator, and can be configured for vaginal penetration and stimulation. Such massagers generally do not allow for multiple vaginal penetration during sexual activity, limiting their use during sexual activity with a partner.

### SUMMARY

Embodiments include a remote-controllable wearable massager for couples including a first arm, a second arm, and a connecting member. The first arm and the second arm are coupled via the connecting member, which is coupled to the proximal ends of the first and second arms. The structure of the massager allows for the first arm of the massager to be inserted into a user's vagina and for the second arm to be in contact with or near the user's clitoris during use. The interior of the first arm can include one or more motors and/or off-center weights or axles, causing the first arm to gyrate in a massaging motion during an operating mode of the massager. The second arm includes a button and a power connector interface. The button can be an on/off switch and can also activate wireless pairing with a remote controller. In addition, the second arm can include an indicator, one or more motors configured to cause the second arm to vibrate during the operating mode, or any combination thereof. In one embodiment, the indicator indicates a power level of the massager and, in another embodiment, the indicator indicates a massage mode of the massager. In one embodiment, the massage mode of the massager can be indicated by the remote controller and, in another embodiment, the massager mode of the massager can be indicated by the button on the second arm. The connecting member can be a spring or a deformable material such that a user can increase, decrease, or adjustably fix the distance between the first arm and the second arm of the massager during use.

During operation, the distal end of the first arm of the massager rotates about the intersection of the proximal end of the first arm and the connecting member. The wearable massager for couples can be made of silicone or another suitable elastic, soft, and durable material, allowing for the rotation of the first arm about the connection between the first arm and the connecting member.

### BRIEF DESCRIPTION OF THE DRAWINGS

FIGS. 1A, 1B, 1C, and 1D collectively illustrate an example of a wearable massager for couples, according to one embodiment.

FIG. 2 is a block diagram of components of a wearable massager for couples, according to one embodiment.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Wearable Massager for Couples

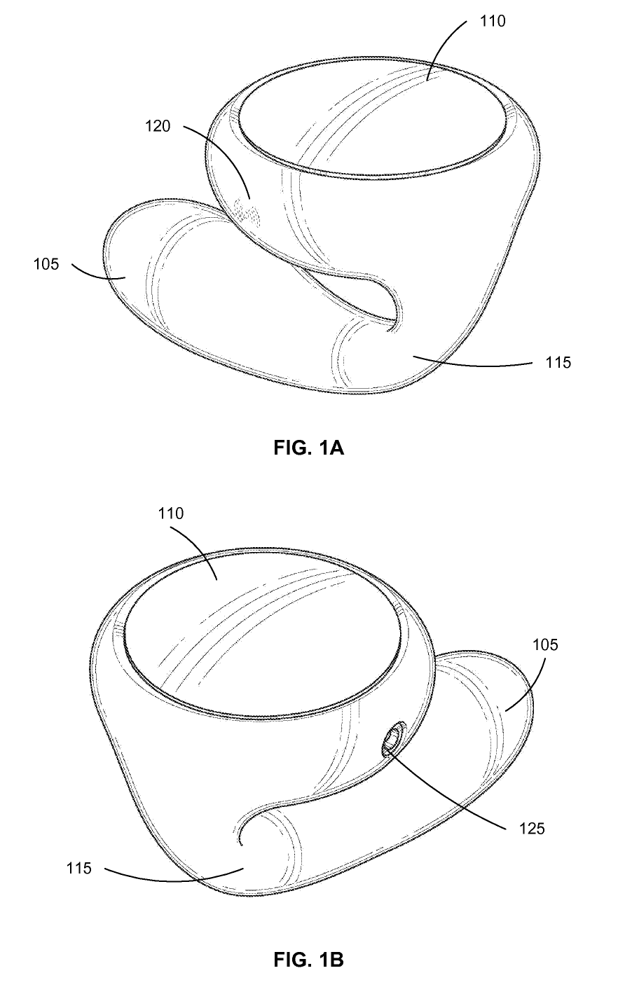

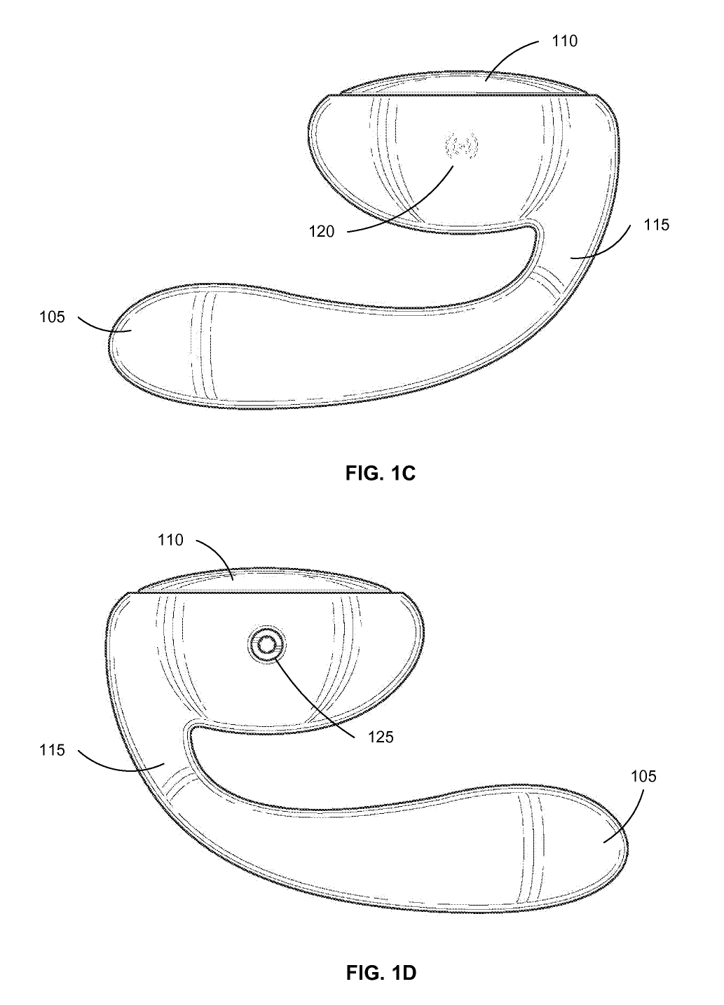

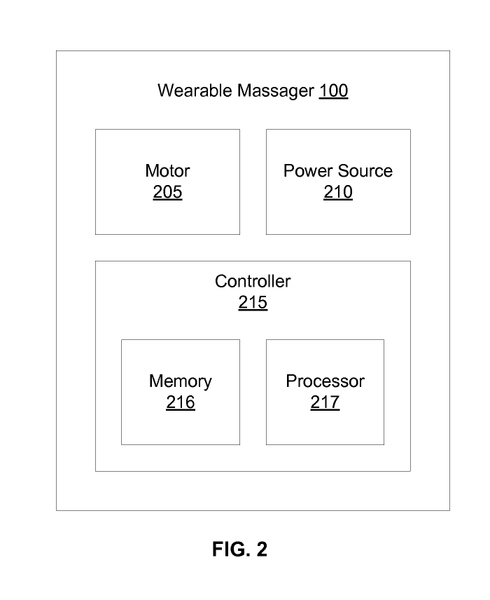

FIGS. 1A, 1B, 1C, and 1D collectively illustrate an example of a hands-free wearable massager 100 for couples, according to one embodiment. FIGS. 1A and 1B illustrate perspective views of the massager 100. FIGS. 1C and 1D illustrate side views of the massager 100. The massager 100 includes a first arm 105, a second arm 110, and a connecting member 115. In other embodiments, the massager 100 can include additional and/or different components to perform the functions as described. The exterior of the massager 100 can be made of a soft and elastic yet durable material, such as silicone, to enable the first arm 105 to rotate about the connecting member 115, massaging the inside surfaces of a user's vagina during use. The material used in the exterior of the massager can be selected from materials known to be non-reactive to human skin, beneficially decreasing the safety risks of using the massager. In addition, the massager 100 can be waterproof and may weigh less than 100 g. The functionalities of the massager 100 are further described below in conjunction with FIG. 2. The first arm 105 is coupled to the second arm 110 through the connecting member 115, which is coupled to the proximal ends of the first arm 105 and the second arm 110.

The massager 100 is structured such that the first arm 105 is inserted into a user's vagina and the second arm 110 is in contact with or near the user's clitoris during use. During use, the connecting arm 115 can be in contact with or near an area between the entry of the vagina and the region near the clitoris. The connecting member 115 and the first arm 110 are configured to allow for a user to simultaneously have intercourse (e.g., vaginal intercourse) with a partner while the massager 100 is being worn by the user. For example, the massager 100 can be worn with the first arm inserted into the vagina of a woman while the penis of a male partner is also inserted into the vagina. The massager 100 can also be worn during other forms of intercourse too.

The first arm 105 includes a distal end and a proximal end (which, as noted above, is coupled to the connecting member 115). In one embodiment, the width along the first arm 105 can vary and is larger near the center of the first arm 105 than at the distal end and the proximal end of the first arm 105. The first arm 105 can taper in width from a first width at or near the distal end of the first arm to a second, smaller width at the proximal end. For example, the width of the first arm 105 can range from 2-3 cm at or near the distal end and 1-2 cm near the proximal end. The length of the first arm 105 from the distal end to the proximal end can be 8-10 cm.

The first arm 105 is configured to rotate in an orbit around an axis substantially perpendicular to a cross-section of a proximal end of the first arm when the massager is in an operating mode. The distal end of the first arm 105 rotates in an orbit with a wider diameter than the center of the first arm 105 and the proximal end of the first arm 105. In one embodiment, the proximal end of the first arm 105 does not rotate but rather pivots at the intersection between the first arm 105 and the connecting member 115. The rotation of the first arm 105 when the massager is in an operating mode causes the first arm 105 to rotatably massage the interior of the user's vagina. In one embodiment, the first arm 105 is configured to vibrate in an operating mode, for instance when the first arm 105 is rotating or when the first arm 105 is not rotating. In various embodiments, the function (i.e., rotation, vibration, etc.) can be specified and selected by a user of the massager 100. For example, the user can select the function through a remote controller that is wirelessly paired to the massager 100. In one embodiment, the remote controller is the remote controller described in U.S. patent application Ser. No. 13/492,909, filed on Jun. 10, 2012, which is hereby incorporated by reference in its entirety.

The second arm 110 includes a distal end and a proximal end (which, as noted above, is coupled to the connecting member 115). In one embodiment, the second arm 110 includes an outer face and a base, and is shorter in length and greater in width than the first arm 105. In the embodiment shown in FIG. 1, the base is a partial oblate spheroid base. However, the base can be an oval shape or any other suitable shape that allows the massager 100 to function as a wearable clip when in use. In one example embodiment, the base can be approximately 3-6 cm in width. The second arm 110 can include a power source 210 for the massager, and can also provide a vibrating or massaging motion when used in an operating mode.

The connecting member 115 is configured to be adjustably fixed for use as a wearable clip by a user during use. For example, the connecting member 115 can be flexible enough such that a user can temporarily separate the first arm 105 and the second arm 110 to accommodate the insertion of the first arm of the massager into the user's vagina but rigid enough to allow the connecting member 115 to forcibly compress the first arm 105 toward the second arm 110, causing the massager to securely clip onto a user. For example, the connecting member 115 can act as a spring with a first spring constant that exceeds a threshold spring constant, limiting the flexibility of the connecting member 115. In other embodiments, the connecting member 115 includes a deformable material that can be reshaped or that is configurable into a plurality of curved shapes. Thus, a user can adjust the shape or curvature of the shape of the connecting member 115 during use, configuring the massager 100 to reduce or increase the distance between the first arm 105 and the second arm 110 to either tighten or loosen the massager 110. Accordingly, the adjustable connecting member 115 allows for insertion of the massager 100 while allowing a user to adjust the massager, when inserted, for comfort.

The massager 100 may also include additional features, such as a button 120 and a power connector interface 125. The button 120 can be an on/off switch for powering the massager 100 on and off. In addition, the button 120 can also activate wireless pairing of the massager 100 to a remote controller used to operate the massager 100. The button 120 may also be used to select a mode of massage or operation of the massager 100 during use. For example, the number of times a user pushes the button 120 can correlate to a mode of massage. The various modes of massage or operation can include different combinations, patterns, speeds, or intensities of vibrations, rotations, durations of vibrations, or any other suitable massaging motions. In some embodiments, the various modes of massage or operation can vary based on motion-sensing, as described in U.S. patent application Ser. No. 13/492,909, filed on Jun. 10, 2012, the contents of which are hereby incorporated in their entirety. In another embodiment, the remote controller comprises a motion sensor and the massager 100 operates responsive to the motion sensed by the remote controller. In one embodiment, the massager 100 comprises 6-10 modes of massage or operation, which, as used herein, a mode of operation can also be referred to as a “simulation mode”.

The power connector interface 125 allows for recharging the power source of the massager 100 in a non-operating mode. For instance, the power connector interface 125 can allow for the insertion of a power cable to allow a user to electrically couple the massager 100 to a power outlet, allowing the massager 100 to draw power from the power outlet to recharge.

The massager 100 can also include an indicator to indicate power levels of the massager 100. For example, the indicator can indicate a power level of a power source within the massager 100, such as a battery or lithium-ion battery. The power level can be shown by lighting a number of light segments on the indicator reflective of the power level.

The indicator can also indicate a mode of massage or operation of the massager 100 during use, which can be selected by the user. The operating mode of massage can be shown through the indicator, for instance through various colors, indicator lights, symbols, and the like.

In one embodiment, the operating mode can also be selected by the user through an interface on the massager 100. The interface can include one or more additional buttons, in addition to the previously-described button 120, associated with the various operating modes, and is accessible to the user. For example, the interface comprising the one or more additional buttons can be integrated into the second arm 110, and can be accessible by the user during use of the massager 100.

FIG. 2 is a block diagram of components of a wearable massager for couples, according to one embodiment. This Figure provides an example of some of the components that might be included in the massager 100, though some designs may include different components. The massager 100 shown in FIG. 2 includes one or more motors 205, a power source 210, and a controller 215. The controller 215 controls the operating mode of the massager 100 using the one or more motors 205 and using power from the power source 210. In addition, the massager 100 can include sensors, such as a motion sensor.

The one or more motors 205 are integrated in the massager 100 and configured such that the motors rotate the first arm 105 about an axis, such as an axis that intersects a cross-section of the proximal end of the first arm 105 and/or the connecting member 115. In addition, the one or more motors 205 are also configured to provide vibrations within the first arm 105, the second arm 110, or both during the operating mode. The motors 205 can power rotation of off-center weights located within the first arm 105 and the second arm 110 can cause the rotation and vibration of the first arm 105 and the second arm 110. The one or more motors 205 can be electric or electromagnetic motors, such as an AC motor, a DC motor, or any other suitable motor or mechanism that converts electricity into a mechanical motion.

The power source 210 is electrically coupled to the one or more motors 205, and provides electrical power to the one or more motors 205. The power source 210 can include one or more batteries, lithium-ion batteries, capacitors, or any other suitable power source. The power source 210 is electrically coupled to the power connecting interface 125, and is configured to receive power from an external power source via the power connecting interface 125 to allow for charging the power source 210.

The controller 215 includes memory 216 and a processor 217, and is communicatively coupled to the one or more motors 205. The controller 215 stores one or more operating modes within the memory 216 as computer-executable instructions, each associated with a setting of one or more of vibrations, rotations, duration of vibrations, speed of vibrations and rotations, intensity of vibrations and rotations, diameter of rotations, and the like. The controller 215 implements one or more of the operating modes based on a selected operating mode, for instance by a user of the massager 100, through the massager 100 or remote controller. To implement an operating mode, the processor 217 accesses an operating mode stored in the memory 216, and executes the computer-executable instructions associated with the operating mode. In response, the executed instructions cause the motors 205 to implement vibrations and rotations associated with the operating mode. The massaging patterns of the massager's operating mode can vary in strength and duration, and, for vibration, can be the same or different for the first arm 105 and the second arm 110. In one example operating mode, the first arm 105 rotates at a fixed speed and diameter, and the second arm 110 pulsatingly vibrates.

In one embodiment, the massager 100 can include one or more motion sensors. Based on changes in the x-, y-, or z-axis, as detected by the one or more motion sensors, the mode of massage of the massager 100 can vary. In addition, the remote controller can include the one or more motion sensors and vary the mode of massage of the massager 100 based on detected changes in the x-, y-, or z-axis of the remote controller.

While various embodiments have been described above, it should be understood that they have been presented by way of example only, and not limitation. For example, any of the components may employ any of the desired functionality set forth hereinabove. The functions can be distributed differently across the components or different functions can be combined into one component. The massager can be designed to have a variety of different shapes and sizes, and the embodiments shown herein are simply examples of some such shapes and sizes. The internal components of the massager can vary, and can include fewer or more components that those shown here. Thus, the breadth and scope of a preferred embodiment should not be limited by any of the above-described exemplary embodiments.

What is claimed is:

1. A hands-free massager, comprising:
a first arm structured for insertion into a vagina, a distal end of the first arm configured to rotate in an orbit around an axis substantially perpendicular to a cross-section of a proximal end of the first arm in an operating mode, the first arm tapering in width from a first width at the distal end of the first arm to a second width at the proximal end, the second width comprising a smaller width than the first width;
a second arm shorter in length than the first arm and comprising a partial oblate spheroid base with an outer face, the second arm including one or more batteries within the second arm and a power connector interface electronically coupled to the one or more batteries, the second arm configured to vibrate in the operating mode and structured for contact with a clitoris when the distal end of the first arm is inserted into a vagina; and
a connecting member comprising a curved shape and coupled to the proximal end of the first arm and a proximal end of the second arm, the connecting member comprising a smaller width than the second width of the proximal end of the first arm and a width of the second arm.

2. The massager of claim 1, wherein the first arm is configured to vibrate in the operating mode.

3. The massager of claim 2, wherein the vibration of the first arm comprises one of a selectable plurality of vibration patterns.

4. The massager of claim 1, wherein the vibration of the second arm comprises one of a selectable plurality of vibration patterns.

5. The massager of claim 1, wherein the connecting member is configurable into a plurality of curved shapes.

6. The massager of claim 1, wherein the hands-free massager receives instructions for the operating mode from a remote controller communicatively coupled to the hands-free massager.

7. A hands-free massager, comprising:
a first arm structured for insertion into a vagina, a distal end of the first arm configured to rotate in an orbit around an axis substantially perpendicular to a cross-section of a proximal end of the first arm in an operating mode;
a second arm comprising a partial oblate spheroid base with an outer face, the second arm configured to vibrate in the operating mode and structured for contact with a clitoris when the distal end of the first arm is inserted into a vagina; and
a connecting member coupled to the proximal end of the first arm and a proximal end of the second arm, wherein the connecting member comprises a smaller width than a width of the first arm and a width of the second arm.

8. The massager of claim 7, wherein the first arm is configured to vibrate in the operating mode.

9. The massager of claim 8, wherein the vibration of the first arm comprises one of a selectable plurality of vibration patterns.

10. The massager of claim 7, wherein the first arm tapers in width from a first width at the distal end of the first arm to a second width at the proximal end, the second width comprising a smaller width than the first width.

11. The massager of claim 7, wherein the vibration of the second arm comprises one of a selectable plurality of vibration patterns.

12. The massager of claim 7, wherein the connecting member is configurable into a plurality of curved shapes.

13. The massager of claim 7, wherein the hands-free massager receives instructions for the operating mode from a remote controller communicatively coupled to the hands-free massager.

14. A hands-free massager, comprising:
a first arm structured for insertion into a vagina, a distal end of the first arm configured to rotate in an orbit;
a second arm comprising a base, the second arm configured to vibrate and structured for contact with a clitoris when the distal end of the first arm is inserted into a vagina; and
a connecting member coupled to a proximal end of the first arm and a proximal end of the second arm, wherein the connecting member comprises a smaller circumference than a circumference of the first arm and a circumference of the second arm.

15. The massager of claim 14, wherein the first arm is configured to vibrate in the operating mode.

16. The massager of claim 15, wherein the vibration of the first arm comprises one of a selectable plurality of vibration patterns.

17. The massager of claim 14, wherein the first arm tapers in width from a first width at the distal end of the first arm to a second width at the proximal end, the second width comprising a smaller width than the first width.

18. The massager of claim 14, wherein the vibration of the second arm comprises one of a selectable plurality of vibration patterns.

19. The massager of claim 14, wherein the connecting member is configurable into a plurality of curved shapes.

20. The massager of claim 14, wherein the hands-free massager receives instructions for the operating mode from a remote controller communicatively coupled to the hands-free massager.
